(19) United States
(12) Patent Application Publication
(10) Pub. No.: US 2005/0262520 A1
(43) Pub. Date: Nov. 24, 2005

(54) Methods for standard mechanisms for digital item manipulation and handling

(75) Inventors: Ian Shaw Burnett, Figtree (AU); Gerrard Matthew Drury, Wollongong (AU)

Correspondence Address: WELSH & KATZ, LTD, 120 S RIVERSIDE PLAZA, 22ND FLOOR, CHICAGO, IL, 60606, US

(73) Assignee: University of Wollongong, Wollongong (AU)

(21) Appl. No.: 10/616,010

(22) Filed: Jul. 9, 2003

(30) Foreign Application Priority Data
Jul. 11, 2002 (AU) 2002950202

(51) Int. Cl. G06F 9/00

(52) U.S. Cl. 719/320

(57) ABSTRACT

A method and apparatus for enabling a Digital Item to be consumed or otherwise manipulated according to a set of operations defined by the Digital Item author or other entitled party, the method including the step of incorporating a Digital Item manipulation method or methods defining said set of operations into the Digital Item.

### TECHNICAL FIELD

The present invention relates to Digital Items [1] that are considered as a Digital Object containing structure, metadata and resources. This invention more particularly relates to a method and apparatus for the assignment of methods for Digital Item handling and manipulation. The methods alter a Digital Item from being a passive container object to a container with active methods describing the mechanisms by which the structure, metadata and resources may be used.

Terms and Definitions

The following terms are used throughout the specification with the meanings and in the context described.
Digital Item—a digital object containing structure, metadata and resources. Digital Items may be declared using the Digital Item Declaration Language (DIDL), typically specified by the MPEG-?1 standard [2] which is incorporated herein by cross reference, however, it will be appreciated that the invention is not limited to a Digital Item defined by such a DIDL and other definitions are equally applicable.
Digital Item Declaration—a specification for declaring a Digital Item including the structure, metadata, and resources it contains. As specified by MPEG-21 it includes an abstract model, a normative description of syntax and semantics of an XML-based language for representing a Digital Item conforming to the model [2].
Digital Item Adaptation—a means by which a Digital Item may be adapted based on information such as user preferences, device capabilities, network capabilities, and environment. As specified by MPEG-21 it is described in [4] and is incorporated herein by cross reference.
Digital Item Manipulation Method—a prescribed set of steps by which a Digital Item and thus its resources and metadata may be presented, consumed or otherwise manipulated by an application software intended to receive, transmit or otherwise handle a Digital Item.
DIScript—a scripting language by which a Digital Item Manipulation Method is described as a set of operational steps. This is interpreted by application software intended to receive, transmit or otherwise handle a Digital Item.
Intellectual Property Management and Protection (IPMP)—a means by which rights for intellectual property may be electronically managed and protected.
Script Processing Engine—an entity that is able to interpret a scripting language and execute the described operational steps. This also includes such things as providing an executing script with access to structure information, metadata, and resources contained in the Digital Item, managing the data and memory requirements of an executing script, providing access to system resources to an executing script, and all other aspects required to execute a script. A DIScript Processsing Engine is such an entity for interpreting and executing methods described in the DlScript scripting language. Some implementations of a script processing engine may be implemented as a virtual machine.

### BACKGROUND OF THE INVENTION

Situations may arise where it is necessary for Digital Items to be handled and manipulated in a defined or constrained manner. The Digital Item acts purely as a containing structure for metadata and resources and has no information on the operations, order of operations, operations required by the Digital Item author or other such prescribed operations that should be performed upon receipt or during manipulation of the Digital Item.

As an example consider the following scenarios:

A Digital Item representing a music album is requested by a user. The Digital Item contains multiple soundtracks as well as associated video clips. The publisher of the Digital Item music album wishes to ensure that track 1 is played automatically on receipt of the Digital Item and that the remaining music tracks and video clips are played in a certain order.

To allow the publisher to have control of the operations undertaken by a device on receipt of the Digital Item it is necessary for the Digital Item to contain a Digital Item Manipulation Method relaying the publisher's instructions and choices.

The same Digital Item may be requested by a user who wishes to add extra music tracks, personal preference data, or annotations to each music track. In this case it is essential for compatibility and interoperability that the changes made by the user are performed according to the prescribed structure of the Digital Item.

To allow the publisher to have control of the operations that a user making changes to the Digital Item may perform it is necessary for the Digital Item to contain a second Digital Item Manipulation Method relaying the publisher's instructions and choices.

In a second scenario a ‘learning’ Digital Item might play the role of a learning object. In this case the Digital Item would consist of a series of interactive lessons. The pupil is required to perform the tasks in the lessons and then fill in forms with the answers. It is essential that the pupil should perform lessons in a prescribed order, complete a percentage of each lesson successfully before proceeding and transmit the answers to problems back to the teacher in a second Digital Item. These constraints and operational procedures may be provided by a Digital Item Manipulation Method as part of the learning Digital Item.

In a third scenario a ‘travel’ Digital Item may be sent to a user. The Digital Item contains booking forms, travel pictures, videos, text file descriptions, background audio and web page links. The question that is answered by the present invention is ‘what a device should do on receipt of such a Digital Item’. Without this solution it is quite reasonable for a device to store the booking forms, ignore the text files, send the videos to another device, and display one of the web page links. The Digital Item Manipulation method would ensure that the pictures and description are displayed with the background audio. Then videos are made available based on the users choices, the web page links displayed and the relevant booking forms are then displayed for form-filling with the results transmitted securely back to the travel server.

It will be understood that the operations described by the Digital Item Manipulation Method may require Rights information to be expressed. Such Rights expressions are not intended to be part of this specification and might be expressed using the MPEG-21 Rights Expression Language [5] or similar. The intention of the Digital Item Manipulation method is to express the operations that are or may be required to achieve a given interaction with a Digital Item.

It will be seen that the incorporation of Digital Item Manipulation Methods in Digital Items significantly improves the functionality and usefulness of Digital Items. Through a novel extension which will fits naturally into the DIDL, an optional linkage between a Digital Item, its resources and the necessary processing is established. This is performed such that the concept of a Digital Item is in no way encumbered and only enhanced for all applications.

For a Digital Item to be interoperable and for devices to be proved conformant, it is necessary to ensure that a fixed set of operations be performed on said Digital Item for a given purpose. Thus the Digital Item shall contain a Digital Item Manipulation Method for that, or a subset of that purpose. When no Digital Item Manipulation method is present for the required purpose then the application is free to interact with the Digital Item as it considers appropriate. In general this is undesirable and unacceptable for the purposes of an interoperable multimedia framework. It should be noted that the receipt of a Digital Item. without a Digital Item Manipulation Method may also be handled using the present invention. In that case the Digital Item Manipulation Method is a default method provided by the application or device.

### DISCLOSURE OF THE INVENTION

The present invention seeks to provide a method and system to provide the desirable outcomes described above.

According to one aspect, the present invention provides a method of enabling a Digital Item to be consumed or otherwise manipulated according to a set of operations defined by the Digital Item author or other entitled party, the method including the step of incorporating a Digital Item manipulation method or methods defining said set of operations into the Digital Item.

According to a second aspect, the present invention provides a method of enabling a Digital Item to be consumed or otherwise manipulated according to a set of operations defined by the Digital Item author or other entitled party, the method includes the following steps:
i) incorporating a Digital Item manipulation method or methods defining said set of operations into a Digital Item;
ii) providing said Digital Item, or a Digital Item declaration to a device;
iii) enabling said device to:
   a) determine an appropriate Digital Item manipulation method or methods for the application;
   b) retrieve said appropriate Digital Item manipulation method or methods;
   c) interpret said set of operations from said appropriate Digital Item manipulation method or methods; and
   d) perform interpreted set of operations from said Digital Item manipulation method or methods on said Digital Item.

According to a third aspect, the present invention provides a method of enabling a Digital Item to be consumed or otherwise manipulated according to a set of operations defined by the Digital Item author or other entitled party, the method includes the following steps:
i) incorporating a Digital Item manipulation method or methods defining said set of operations into a Digital Item;
ii) providing said Digital Item, or a Digital Item declaration to a device;
iii) enabling said device to:
   a. determine an appropriate Digital Item manipulation method or methods for the application;
   b. retrieve said appropriate Digital Item manipulation method or methods;
   c. receive and be configured on the basis of other predetermined information;
   d. interpret said set of operations from said appropriate Digital Item manipulation method or methods; and
   e. perform said interpreted set of operations from said Digital Item manipulation method or methods on said Digital Item.

According to a fourth aspect, the present invention provides a method of enabling a Digital Item to be consumed or otherwise manipulated according to a set of operations defined by the Digital Item author or other entitled party, the method includes the following steps:
i) incorporating a Digital Item manipulation method or methods into a Digital Item defining said set of operations;
ii) providing said Digital Item, or a Digital Item declaration to a device;
iii) enabling said device to:
   a. determine an appropriate Digital Item manipulation method or methods for the application;
   b. retrieve said appropriate Digital Item manipulation method or methods;
   c. configure said appropriate Digital Item manipulation method or methods for said Digital Item;
   d. interpret said set of operations from said appropriate Digital Item manipulation method or methods; and
   e. perform said interpreted set of operations from said Digital Item manipulation method or methods on said Digital Item.

According to a fifth aspect, the present invention provides a method of enabling a Digital Item to be consumed or otherwise manipulated according to a set of operations defined by the Digital Item author or other entitled party, the method includes the following steps:
i) incorporating a Digital Item manipulation method or methods defining said set of operations into a Digital Item;
ii) providing said Digital Item, or a Digital Item declaration to a device;
iii) enabling said device to:
   a. determine an appropriate Digital Item manipulation method or methods for the application;
   b. retrieve said appropriate Digital Item manipulation method or methods;
   c. configure said appropriate Digital Item manipulation method or methods for said Digital Item;
   d. receive and be configured on the basis of other predetermined information;
   e. interpret said appropriate Digital Item manipulation method or methods; and
   f. perform said interpreted operations from said Digital Item manipulation method or methods on said Digital Item.

In one variation, step iii) b may not be required as the Digital Item manipulation method or methods may be contained in the Digital Item or Digital Item declaration provided in step ii) or is already known to the device. A second variation may combine steps iii)e and iii)f into a single step.

Preferably, the other predetermined information includes information regarding user preferences, device capabilities and/or consumption environment.

According to sixth aspect, the present invention provides apparatus for enabling a Digital Item to be consumed or otherwise manipulated according to a set of operations defined by the Digital Item author or other entitled party, the apparatus including:
i) means for incorporating a Digital Item manipulation method or methods defining said set of operations into a Digital Item;
ii) means for providing said Digital Item, or a Digital Item declaration to a device;
iii) said device including:
   a. means for determining an appropriate Digital Item manipulation method or methods for the application;
   b. means for retrieving said appropriate Digital Item manipulation method or methods;
   c. means for interpreting said set of operations from said appropriate Digital Item manipulation method or methods; and
   d. means for performing said interpreted set of operations from said Digital Item manipulation method or methods on said Digital Item.

According to a seventh aspect, the present invention provides apparatus for enabling a Digital Item to be consumed or otherwise manipulated according to a set of operations defined by the Digital Item author or other entitled party, the apparatus including:
i) means for incorporating a Digital Item manipulation method or methods defining said set of operations into a Digital Item;
ii) means for providing said Digital Item, or a Digital Item declaration to a device;
iii) said device including:
   a. means for determining an appropriate Digital Item manipulation method or methods for the application;
   b. means for retrieving said appropriate Digital Item manipulation method or methods;
   c. means for receiving and being configured on the basis of other predetermined information;
   d. means for interpreting said set of operations from said appropriate Digital Item manipulation method or methods; and
   e. means for performing said interpreted set of operations from said Digital Item manipulation method or methods on said Digital Item.

According to a eighth aspect, the present invention provides apparatus for enabling a Digital Item to be consumed or otherwise manipulated according to a set of operations defined by the Digital Item author or other entitled party, the apparatus including:
i) means for incorporating a Digital Item manipulation method or methods defining said set of operations into a Digital Item;
ii) means for providing said Digital Item, or a Digital Item declaration to a device;
iii) said device including:
   a. means for determining an appropriate Digital Item manipulation method or methods for the application;
   b. means for retrieving said appropriate Digital Item manipulation method or methods;
   c. means for configuring said appropriate Digital Item manipulation method or methods for said Digital Item;
   d. means for interpreting said set of operations from said appropriate Digital Item manipulation method or methods; and
   e. means for performing said interpreted set of operations from said Digital Item manipulation method or methods on said Digital Item.

According to a ninth aspect, the present invention provides apparatus for enabling a Digital Item to be consumed or otherwise manipulated according to a set of operations defined by the Digital Item author or other entitled party, the apparatus including:
i) means for incorporating a Digital Item manipulation method or methods defining said set of operations into a Digital Item;
ii) means for providing said Digital Item, or a Digital Item declaration to a device;
iii) said device including:
   a. means for determining an appropriate Digital Item manipulation method or methods for the application;
   b. means for retrieving said appropriate Digital Item manipulation method or methods;
   c. means for configuring said appropriate Digital Item manipulation method or methods for said Digital Item;
   d. means for receiving and being configured on the basis of other predetermined information;
   e. means for interpreting said set of operations from said appropriate Digital Item manipulation method or methods; and
   f. means for performing said interpreted operations from said Digital Item manipulation method or methods on said Digital Item.

Digital Item manipulation methods may be classified according to standard applications and new applications that arise may be identified through the mechanism of a naming authority or other such means. Multiple methods may be executed simultaneously.

It will be appreciated that the operations used in the set of operations may be standard operations and the author defines which standard operations form the set, typically, in the form of a script.

Digital Item Manipulation methods may be provided to a device as a method in the form of a set of operations described in a script; said script included in the Digital Item as:
i) A resource within the Digital Item accessed by a reference URI from the Digital Item declaration
ii) A script provided within the Digital Item declaration itself as a descriptor
iii) A script referenced by an identifier such that a device, or a family of devices might have the operations of said script in-built at manufacture or by later modification
iv) A separate Digital Item
v) A standard script, identified by reference, which is annotated, improved or in some way altered by a second script provided by one of the means i) to iv).
vi) A default script held by the device or application and used when a Digital Item provides no methods

The inclusion of the script into a Digital Item provided to a device by one of these means includes any format in which a Digital Item may be declared, including, but not limited to, plain text conforming to a specification for Digital Items such as MPEG-21 DIDL, binary formats of said Digital Items, and other file formats containing a Digital Item.

The number of Digital Item Manipulation methods provided within any Digital Item would not normally be limited and is at the discretion of the author.

The operations defined by a Digital Items Digital Item Manipulation method will define the necessary functionality and hence architecture of a device that may legitimately and successfully receive said Digital Item using that method. A device that has limited functionality or missing architectural elements may:
i) Attempt to interpret the Digital Item Manipulation Method but report errors due to limited functionality to the user or some other device or entity
ii) Attempt to interpret the Digital Item Manipulation Method and ignore all errors
iii) Attempt to interpret the Digital Item Manipulation Method and perform operations on errors at and degree between i) and ii) above

The invention thus further provides, at least in its embodiments, a mechanism for the test of a device for its ability to meet a normative specification of a standard or some profile of the standard (where a profile might allow for reduced complexity devices and/or reduced functionality devices). Further, through the identification of methods which a device can perform on a Digital Item, this specification allows for the classification of devices in terms of their level of functionality within the MPEG-21 standard and other standards using Digital Items or similar. Thus this invention provides, in one embodiment, mechanisms by which conformance and interoperability of MPEG-21 and other Digital Item consuming devices may be established.

Digital Item manipulation methods may not necessarily be targeted only at terminating equipment. Other embodiments of the present invention provide methods that provide an intermediate node with instructions as to how to manipulate and alter a Digital Item. In one preferred embodiment, the Digital Item manipulation methods may give a wireless network gateway instructions as to how to process a Digital Item so as to make the contents appropriate to a wireless, low bandwidth environment.

In certain situations Digital Items may require the download or acquisition by some means of a tool that can process descriptors and or resources. In such case, the Digital Item Manipulation Method may be used to specify the tools to download and the operations to perform such that appropriate resources and descriptors from the Digital Item are processed by the tool.

Digital Item Manipulation methods act upon elements in the Digital Item. Since the actual elements within a Digital Item are not known at the time the method is implemented, this invention also specifies a mechanism for identifying to the method the elements of a Digital Item that it can process.

While the present invention is not specifically intended to handle IPMP mechanisms, it will be appreciated that such mechanisms could simply be incorporated into a Digital Item Manipulation Method. Further, Digital Item Manipulation Methods may themselves be protected using IPMP mechanisms. In these cases, it will be appreciated that the DlScript Processing Engine and appropriate Digital Item Manipulation Methods may control the whole IPMP protected device rather than simply the Digital Item manipulation.

### BRIEF DESCRIPTION OF THE DRAWINGS

Preferred embodiments of the invention will now be described, by way of example only, with reference to the accompanying examples and drawings in which:

FIG. 1 shows a schematic diagram of the basic architecture for processing of Digital Item Manipulation Method script; and

FIG. 2 shows a schematic diagram of a sample flow of control between a device, the script processing engine and the Digital Item Manipulation Method.

### PREFERRED EMBODIMENTS OF THE INVENTION

In a preferred embodiment the Digital Item Manipulation Method is provided as a resource of a Digital Item. On receipt of a Digital Item a device shall find the Digital Item Manipulation Method appropriate to the task to be undertaken.

The Digital Item declaration language (DIDL) provides tools that may be used to achieve the goal of incorporating Digital Item manipulation methods into Digital Items.

The elements of DIDL that may be used for this purpose may include, but are not limited to:
Component—binds a set of Descriptors to a Resource.
Descriptor—allows the inclusion of any descriptive metadata for elements within a Digital Item.
Item—binds together a set of Descriptors to a set of Components and/or sub-Items.
Resource—the element that, typically, represents a consumable resource. Examples include text, image, audio, and video resources, but is not limited to media resources of these types.
Statement—an element that may be contained by a Descriptor and allows the inclusion of metadata from any schema. This provides a means for incorporation of a Digital Item Manipulation method or methods, and related metadata, in a Digital Item.

The following is an example of this preferred embodiment that demonstrates the incorporation by reference of a set of methods for processing a music album.

```
<Descriptor>
    <Statement type=”text/discript+xml”>
        <discript:method
id=”urn:mpeg:mpeg21:discript:2002:01:StandardMusicAlbum:DisplayAlbum”
          version=”1.0”
ref=”http://mpeg.telecomitalialab.com/discript/2002/01/StandardMusicAlbum/DisplayAlbum.dsl”
          desc=”Open Music Album”
          invokeOn=”receipt” />
    </Statement>
</Desciptor>
<Descriptor>
    <Statement type=”text/discript+xml”>
    <discript:method
id=”urn:mpeg:mpeg21:discript:2002:01:StandardMusicAlbum:previewTracks”
ref=”http://mpeg.telecomitalialab.com/discript/2002/01/StandardMusicAlbum/previewTracks.dsl”
          desc=”Preview Tracks”
          invokeOn=”userSelection” />
    </Statement>
</Desciptor>
<Descriptor>
    <Statement type=”text/discript+xml”>
        <discript:method
id=”urn:mpeg:mpeg21:discript:2002:01:StandardMusicAlbum:playTrack”
          version=”1.0”
ref=”http://mpeg.telecomitalialab.com/discript/2002/01/StandardMusicAlbum/playTrack
.dsl”
          desc=”Play Track”
          invokeOn=”userSelection”>
            <discript:methodParam
              type=”standardMusicAlbumTrack” required=”false” />
            <discript:methodRequirements>
                <discript:diaRequirements>
                    <dia:terminalCapabilities>
                        ...
                    </dia:terminalCapabilities>
                </discript:diaRequirements>
            </discript:methodRequirements>
        </discript:method>
    </Statement>
</Desciptor>
<Descriptor>
    <Statement type=”text/discript+xml”>
        <discript:method
id=”urn:mpeg:mpeg21:discript:2002:01:StandardMusicAlbum:addTrack”
          version=”1.0”
ref=”http://mpeg.telecomitalialab.com/discript/2002/01/StandardMusicAlbum/addTrack
.dsl”
          desc=”Add Track”
          invokeOn=”userSelection” />
    </Statement>
</Desciptor>
<Descriptor>
    <Statement type=”text/discript+xml”>
        <discript:method
id=”urn:mpeg:mpeg21:discript:2002:01:StandardMusicAlbum:removeTrack”
          version=”1.0”
ref=”http://mpeg.telecomitalialab.com/discript/2002/01/StandardMusicAlbum/removeTrack.dsl”
          desc=”Remove Track”
          invokeOn=”userSelection” />
    </Statement>
</Desciptor>
```

### EXAMPLE 1

### Incorporation of a Digital Item Manipulation Method into a Digital Item

In this example, the id attribute provides a globally unique identifier for the method. The ref attribute indicates where the script for the method can be located. The desc attribute provides a short human readable description of the method (note that the script may or may not be able to provide a locale specific description). The invokeOn attribute informs the device the intended means and/or time at which the method is to be invoked. If set to receipt, then the method should be invoked when the Digital Item is received for consumption by an end user. Other possible values for the invokeOn attribute includes, but is not limited to, userSelection indicating the method should be presented to the user for selection, and invoked when selected. Methods providing editing functionality could be subject to IPMP and rights management.

The playTrack method also illustrates the usage of an optional parameter to be provided to the method when it is invoked. If the method is user selectable, then the device could add an additional condition on the availability of the method, depending on whether the appropriate Digital Item elements for the parameters were selected, or otherwise available.

The playTrack method also illustrates the inclusion of Digital Item adaptation information specifying the device requirements for this method to be successfully invoked.

The MIME type “text/discript+xml” identifies the XML description of a Digital Item Manipulation method included within XML documents (utilising XML namespaces as required). In the preferred embodiment, the actual methods will be implemented in a non-XML scripting language, however, it will be apparent that the methods may be implemented in many types of computer language. The preferred embodiment of this scripting language described in this specification is the DIScript.

Sets of methods can also be defined. A set, or sets, of methods that includes the methods required for handling a Digital Item can then be specified instead of listing each method.

```
<Descriptor>
    <Statement type=”text/discript+xml”>
        <discript:methodSet
id=”urn:mpeg:mpeg21:discript:2002:01:StandardMusicAlbum:
BasicMethodSet”
          version=”1.0”
          ref=”
http://mpeg.telecomitalialab.com/discript/2002/01/StandardMusicAlbum/
BasicMethodSet.dms”/>
    </Statement>
</Desciptor>
```

### EXAMPLE 2

### Incorporation of a Digital Item Manipulation Method set into a Digital Item

This can also provide a mechanism by which devices can be tested to be conformant to a specified set, or sets, of methods. Typically a method set will include related methods for processing of certain types of Digital Items.

One example of usage by non-terminating equipment, is a network node that supports a method set that includes a method to adapt the Digital Item to a given bandwidth. The network node, if it decides it needs to apply this method, could use the method included in the Digital Item itself, if it does include one, or it may choose to do the adaptation by some other internally implemented method, or by a separately referenced method held externally or internally to the server.

It can be seen that interoperability among devices supporting Digital Items will benefit from the definition of standard methods and standard method sets. An author can utilise these standard methods and standard method sets to ensure the Digital Item they have created will be handled in a standard manner, however customised methods can also clearly be included for specialised handling of a particular instance of a Digital Item.

A Digital Item may also contain a special Digital Item Manipulation Method which provides for a choice of Digital Item Manipulation Methods with which to handle the Digital Item. This functionality may be provided within the script itself, however an alternative is to use the Choice functionality of the DIDL. In either case, the choice of methods may be made by the user, application, on the basis of rights expressed in a Digital Item, or according to some other requirement as appropriate.

The actual elements within a Digital Item that a Digital Item Manipulation Method will process are generally not known when the method is implemented. However, if a method is intended to process a given type of Digital Item, the nature of the elements it can expect is known. This specification utilises this to enable the author of a Digital Item to identify to the method which elements within a Digital Item the method can, and should, process. For this purpose, the preferred embodiment utilises the mechanism of a mapping from Digital Item element to an object type that the method recognises and can process. This mapping is part of part of the configuration of the Digital Item manipulation method for a particular Digital Item and may be specified, for example, in a separate configuration file or included in the Digital Item

The information to enable this mapping must be supplied as the elements in the Digital Item are created, or otherwise modified, when the Digital Item is authored, edited, or at any other convenient point of manipulation. In practice, authoring and other tools that manipulate Digital Items, which may themselves utilise a Digital Item Manipulation method, will be able to generate this mapping information on behalf of the user.

The mapping information can be contained within the Digital Item itself, or else a reference to a separate file containing the mapping information can be used.

One implementation of this mapping mechanism may utilise an explicit map listing. In this implementation elements in the Digital Item that can be processed by a Digital Item Manipulation Method must have an id attribute. The mapping information would then consist of a list that identifies the Digital Item elements by id that correspond to the objects that the method can manipulate. An example of one embodiment is given below.

```
<Decriptor>
    <Statement type=”text/discript+xml”>
        <discript:elementIDToObjectMap>
            <discript:objectTypeByID
              name=”standardDigitalItemTitle”
              elements=”albumTitle” />
            <discript:objectTypeByID
              name=”standardMusicAlbum”
              elements=”musicAlbum” />
            <discript:objectTypeByID
              name=”standardMusicAlbumCover”
              elements=”albumCover” />
            <discript:objectTypeByID
              name=”standardMusicAlbumInfo”
              elements=”albumInfo” />
            <discript: objectTypeByID
              name=”standardMusicAlbumTracks”
              elements=”albumTracks” />
            <discript: objectTypeByID
              name=”standardMusicAlbumTrack”
              elements=”track1 track2 track3 track4 track5
track6 track7” />
            <discript: objectTypeByID
              name=”standardMusicAlbumTrackTitle”
              elements=”track1Title track2Title track3Title track4Title
track5Title track6Title track7Title” />
            <discript:objectTypeByID
              name=”standardMusicAlbumTrackAudio”
              elements=”track1Audio track2Audio track3Audio
track4Audio track5Audio track6Audio track7Audio” />
            <discript:objectTypeByID
              name=”standardMusicAlbumTrackVideo”
              elements=”track3Video track7Video” />
            <discript: objectTypeByID
              name=”standardMusicAlbumTrackInfo”
              elements=”track1Info track2Info track3Info
track4Info track5Info track6Info track7Info” />
    </Statement>
</Descriptor>
```

### EXAMPLE 3

### Mapping of Digital Item elements to Digital Item Manipulation Method Object Types

In the example the first objectTypeByID is the standardDigitalItemTitle which is one of the standard DIScript object types from the DIScript Basic module that all DIScript capable devices implement. The identified Digital Item element is that element that should be used as the title for the Digital Item as it is presented to the end user. Typically, though not necessarily, it will identify only one element that, in the DIDL, will be a Descriptor containing the Digital Item title in a plain text Statement.

In this example, the remaining objectTypeByIDs provide possible examples of object types that may be specified as part of a Standard Music Album method set.

Other implementations may use a different format for the mapping list and may use other ways to identify the Digital Item elements. For example, another alternative illustrated below utilises the element tags directly.

```
<Decriptor>
    <Statement type=”text/discript+xml”>
        <discript:elementTagToObjectMap
          namespace=”urn:mpeg:mpeg21:discript:standardMusicAlbum:
2002:01-StandardMusicAlbum-NS”>
            <discript:objectTypeByTag
              name=”standardDigitalItemTitle”
              tags=”albumTitle” />
            <discript:objectTypeByTag
              name=”standardMusicAlbum”
              elements=”album” />
            ...
            <discript:objectTypeByTag
              name=”otherInfo”
              namespace=”urn:aaa:bbbb:cccc:01234”
              tags=”otherInfo” />
            ...
    </Statement>
</Descriptor>
```

Other implementations of this mapping mechanism may incorporate mapping information within the Digital Item elements themselves. One embodiment of an implementation following this principle is given below. In this embodiment, Descriptors within the elements identify the object type of the parent element for use by the Digital Item Manipulation method.

```
<Item id=”ISRC AU-A01-02-1234”>
    <Descriptor>
        <Statement type=”text/discript+xml”>
            <discript:object type=”standardMusicAlbum” />
        </Statement>
    </Descriptor
    <Descriptor>
        <Descriptor>
            <Statement type=”text/discript+xml”>
                <discript:object type=”standardDigitalItemTitle” />
            </Statement>
        </Descriptor>
        <Statement type=”text/plain”>Australian Sporting
Anthems</Statement>
    </Descriptor>
...
    <Item id=”ISRC AU-A01-02-1234 AlbumTracks”>
...
        <Item id=”ISRC AU-A01-02-1234 Track1”>
            <Descriptor>
                <Statement type=”text/discript+xml”>
                    <discript:object
type=”standarMusicAlbumTrack” />
                </Statement>
            </Descriptor>
            <Descriptor>
                <Descriptor>
                    <Statement type=”text/discript+xml”>
                        <discript:object
type=”standardMusicAlbumTrackTitle” />
                    </Statement>
                </Descriptor>
                <Statement type=”text/plain”>Go you good thing,
go!</Statement>
            </Descriptor>
            ...
            <Component id=” ISRC AU-A01-02-1234 Track1 Audio”>
                <Descriptor>
                    <Statement type=”text/discript+xml”>
                        <discript:object type=”
standardMusicAlbumTrackAudio” />
                    </Statement>
                </Descriptor>
                <Resource
                  type=”audio/mp3”
                  ref=”http://www.ausmusic.com.au/di/albums/
isrc_au_-01-02-1234/tracks/track1/gogood.mp3” />
            </Component>
            ...
        </Item>
    ...
    </Item>
...
</Item>
```

### EXAMPLE 4

### Alternative Binding of Digital Item Elements to Digital Item Manipulation Method Object Types

The object types may be utilised by one or more Digital Item Manipulation methods. Also a single Digital Item element is not limited to a single object type. It may be identified as being of one or more object types, provided that it makes sense to one or more methods that will utilise objects of that type.

The specification of a method will need to include such information as the object types it can manipulate, the allowable Digital Item elements that can be mapped to those object types, plus any other requirements for Digital Item elements of a given object type. Other information that may also be included in a method or method set specification includes, but is not limited to, whether a particular object type is mandatory for Digital Items of that type, the required relationship between objects of given types, allowable number of identified elements of a given type, etc.

Some object types may also be defined such that the mapping is implicit in the definition. In this case no explicit mapping information may be required. For example, an object type of standardDigitalltemRoot, can be defined to map to the top level root element of the Digital Item (the DIDL element, in the case of the DIDL).

The examples provide only an indication of the possibilities and it is expected that this mechanism will be able to be implemented in many other ways all of which fall within the scope of the invention described.

In addition, the usage of method sets specific to different areas of application will also be widely useful. While some methods and method sets may be registered as standards with a registration authority, implementers are still free to define their own methods and method sets.

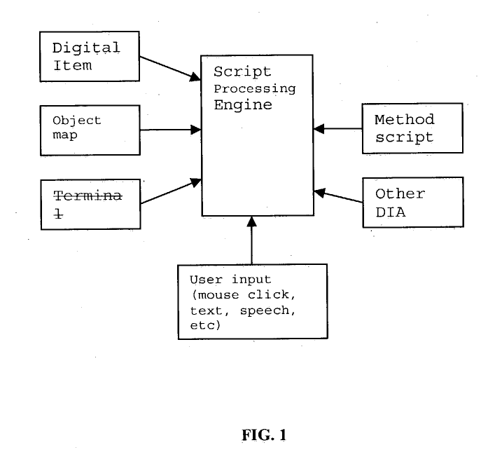

The object map itself may not be utilised within the method script itself, but it may be used as an input into the script processing engine (FIG. 1). The scripting language includes functions to obtain objects of a specified type from the Digital Item. When these functions are executed by the script processing engine it can utilise the object map to locate the Digital Item element and then return it to the script as a script object. It is apparent that the Digital Item declaration, the Digital Item, or both must also be an input to the script processing engine. Other input to the script processing engine may include, but is not limited to, Digital Item adaptation information, and user input such as mouse clicks, input text, etc.

The specification of a method set is defined to include all those parts, as implied in this invention, that must be specified and supported by an implementation to be conformant to that module. This includes, but is not limited to, the object types required by the module, and the Digital Item Manipulation methods of the module.

Discussion on the Apparatus in Relation to the Preferred Embodiment

i) On Means for Incorporating a Digital Item Manipulation Method or Methods into a Digital Item

In one embodiment, Digital Item manipulation methods or method sets may be incorporated into a Digital Item declared in DIDL by use of the Descriptor and Statement elements of the DIDL (see Example 1 and Example 2).

ii) On Means for Providing said Digital Item, or a Digital Item Declaration to a Device

For the purposes of the apparatus, a Digital Item may be supplied to a device by any standard telecommunications, storage retrieval or other such mechanism.

iii) On Means for Said Device to Determine Appropriate Digital Item Manipulation Method or Methods for the Application

At one level, the appropriateness of the actual methods to the said Digital Item is implicit in their specification in the Digital Item by the author. However, certain methods may not be appropriate for usage on a given device or terminal or in a given application. Appropriate methods are thus determined on the basis of their usage being acceptable in a given device or application. Information used in such a determination may include user preferences, device capabilities, network capabilities and consumption environment information. In addition, information included in the method declaration may be used in determining the appropriateness of a method. Method information can easily be extended to allow additional data to be included to assist in method selection by the device, if required.

iv) On Means for Said Device to Retrieve Said Appropriate Digital Item Manipulation Method or Methods

In one embodiment, the location of the script implementing a Digital Item manipulation method is specified. The device may then use this location to retrieve the method. In some cases the method may be contained within the Digital Item itself. In addition some devices may implement an internal implementation of a method as identified by the id attribute of the method information (see Example 1).

v) On Said Device Including Means to Configure Said Appropriate Digital Item Manipulation Method or Methods for Said Digital Item

In one embodiment, configuration of the Digital Item manipulation method for a Digital Item includes the mapping from Digital Item elements to objects of a specific type that are handled by a specific Digital Item manipulation method (see Example 3 and Example 4). Passing of parameters (see Example 1) is also another example of a means by which Digital Item manipulation methods may be configured. The inclusion of further information to configure the method is also possible using these or other means.

vi) On Means for Said Device to Receive and be Configured on the Basis of Other Information Regarding User Preferences, Device Capabilities, and Consumption Environment

The script processing engine has access to Digital Item adaptation information such as user preferences, device capabilities, network capabilities, and consumption environment. This information may be contained within the Digital Item, in a separate Digital Item or other file, received over a network connection, or known implicitly by the script processing engine. This information can be utilised by the scripting engine to configure the device for consumption of the Digital Item. The information can also be made available to the Digital Item manipulation method through appropriate scripting language function calls.

vii) On Said Device Including Means to Interpret Said Appropriate Digital Item Manipulation Method or Methods

The interpretation of the Digital Item manipulation method is fulfilled by the script processing engine as discussed above.

viii) On Said Device Including Means to Perform Interpreted Operations from Said Digital Item Manipulation Method or Methods on Said Digital Item

The performing of interpreted operations of the Digital Item manipulation method is fulfilled by the script processing engine as discussed above.

Sample flow of control

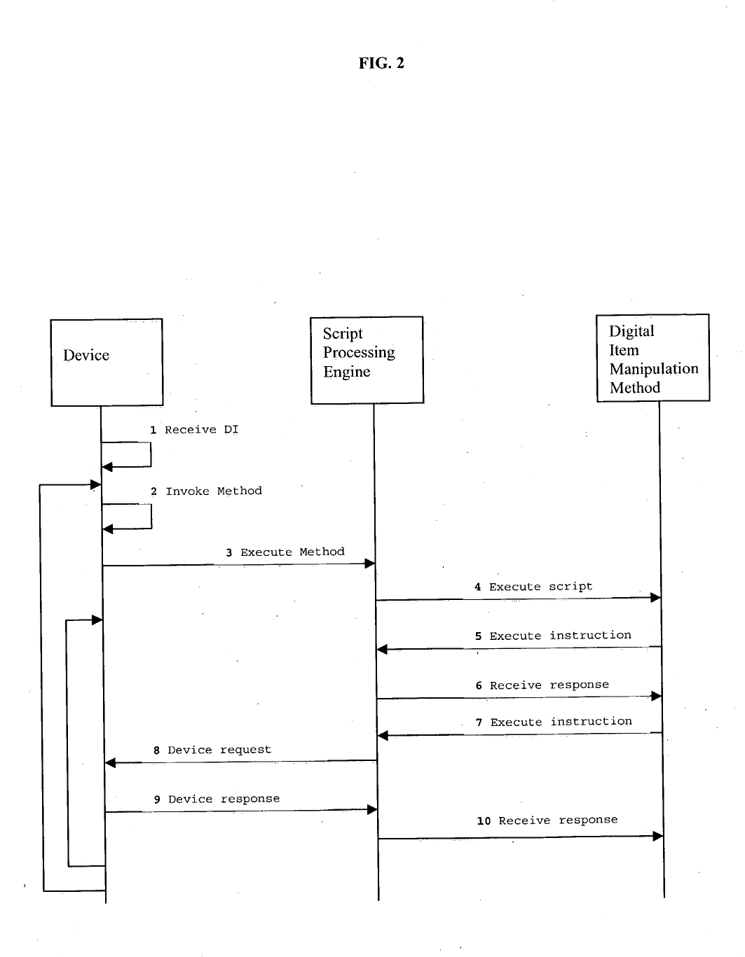

FIG. 2 illustrates a sample flow of control.
1 The device receives a Digital Item. This may be via any standard telecommunications, storage retrieval, or other such mechanism.
2 The device determines the Digital Item Manipulation method or methods appropriate to handle the Digital Item. In this scenario a method is defined to be invoked on receipt of the Digital Item. The appropriateness and availability of the method or methods may be configured by conditions implemented by elements within the Digital Item, or other sources of information such as user preferences and device capabilities. The method to be invoked is then loaded by the device. It may be received via any standard telecommunications, or it may be contained within the Digital Item, or it may be internally implemented within the device.
3 The device then utilises the script processing engine to execute the method. Typically, the device as represented here will carry out its functionality in relation to receiving and manipulating Digital Items through some software executing within an execution environment on the device. In some implementations the script processing engine may be integrated directly into such software. On a desktop computer this may be an application running under the host operating system. For a digital television set top box it may be the onboard software programmed in to the set top box by the manufacturer.
4 The script processing engine then executes the script defining the method. Note that this requires the script processing engine to parse and interpret the script. Although it is the script processing engine that does this, effectively at this stage the control passes to the method script.
5 An operation defined by the script is invoked. This translates to the script making a request to the script processing engine. In this example it is a request that is implemented within the script processing engine itself. For example it may be a query for capabilities of the script processing engine.
6 The script processing engine executes the request and, if appropriate, returns a response to the script.
7 In this example the request requires assistance from the device. First the script sends the request to the script processing engine.
8 The script processing engine makes requests to the device to assist it in fulfilling the request from the script.
9 The device executes the request from the script processing engine and, if appropriate, returns a response to the script processing engine.
10 The script processing engine, if appropriate, returns a response to the script.
   The steps 5 through 10 are repeated until all operations defined by the script are executed.

The steps 2 through 10 are repeated for each method that is invoked.

Scripting Language

In general, the Digital Item Manipulation Method scripting language allows a Digital Item author to provide instructions as to how to treat, interact and consume a Digital Item such that the authors intent is maintained. It enables the author and consumer to move beyond just random access to contents of a Digital Item and to create and experience a true Multimedia experience. It also enables the author to enforce an order on consumption of a Digital Item parts, for example, to provide a path or paths through the contents.

The base functionality required by the scripting language used to describe the operations of a Digital Item Manipulation Method may include:

Display

This functionality allows for the display of elements contained in the Digital Item to the user. Information that may be included in a display request includes basic display layout parameters. e.g.

display( Item );
display( Item, displayParams );

### EXAMPLE 5

### Scripting Language Example for Displaying a Digital Item Element

Edit

This functionality allows for editing a Digital Item, in part or whole. It includes the ability to create, add, and remove elements (such as Descriptors, Resources, Items, Containers etc). Editing functions may also be subject to rights expressions. e.g.

```
object albumTracks = getObjectOfType( “standardMusicAlbumTracks” );
if( albumTracks != null && canAddTo( album ) ) {
    object Item = createElement( “Item” );
    setAttribute( Item, “id”, “track8” );
    object descriptor = createElement( “Descriptor” );
    setAttribute(descriptor, “id”, “track8Title” );
    object statement = createElement( “Statement” );
    setAttribute(statement, “type”, “text/plain” );
    setValue( statement, newTrackTitle );
    appendChild( descriptor, statement );
    appendChild( Item, descriptor );
    ...
    album.appendChild( Item );
}
```

### EXAMPLE 6

### Scripting Language Example for Editing a Digital Item

The functionality of the scripting language itself can be grouped into modules that may include functions defined as part of the scripting language itself, libraries of derived functions implemented in the scripting language, methods, and interface to functionality implemented external to the scripting language and script processing engine. For instance, the above example suggests the grouping of functions providing a DOM API into a DOM related module.

These functions can also be utilised to create a new Digital Item, for example that may be adapted based on information such as user preferences, device capabilities, or consumption environment.

Also the editing functionality will allow combining of elements from, or the whole of, different Digital Items into other Digital Items.

Play

This functionality allows the playing of resources contained within a Digital Item. e.g.

object albumTrackAudio = getChildObjectOfType {
azlbumTrack. “standardMusicalAlbumTrackAudio” );
play (albumTrackAudio );

### EXAMPLE 7

### Scripting Language Example for Playing a Digital Item Element

As with all script functions, this is interpreted and executed by the script processing engine. How the script processing engine does this is a part of the implementation of the processing engine. For example, an implementation may allow the user to set preferences for external player software to be launched to play media of various types. When such an implementation executes a play instruction it launches the appropriate player software according to the media type of the resource to be played.

However, the scripting language specification specifies a standard base level of semantics and functionality for each scripting language function.

In this sense the scripting language can be understood as the means by which requests can be made to the device (via the script processing engine) to handle the Digital Item in a defined manner.

For functions such as play, the actual resource that is played may additionally be determined by factors such as the state of Choices within the Digital Item itself, or may be programmatically determined in the script. In either case one source of input into such a determination may be Digital Item adaptation information.

Concurrent Operations

This functionality is intended to allow, for example, a music resource to play at the same time that a form to be filled in and submitted is presented to the user. For example, if the scripting language defines a play request to commence playing a resource asynchronously by default, a level of concurrency will be implicit (the scripting language should also allow optional synchronous playing of a resource) e.g.

```
object form = getObjectOfType( “roomReservationForm” );
object presentationInfo = getChildObjectOfType(
                                        form,
“formPresentationInfo” );
object elevatorMusic = getChildObjectOfType( form,
“backgroundAudio” );
play( eleveatorMusic );
if( presentationInfo == null )
    display( form );
else
    present( presentationInfo, form );
```

### EXAMPLE 8

### Scripting Language Example of Concurrent Play and Presentation Operations

Complete a Form

This functionality includes presenting a form to the user and taking appropriate action when the form is submitted.

The components of the form may be defined by elements contained in the Digital Item. The scripting language can be used to retrieve the components and compose them into the required layout for the form, then present the form, and respond to user input to the form.

The presentation layout information may also be contained within the Digital Item. In this case the layout information is retrieved and passed, along with the resource to be presented, to the presentation function of the scripting language. The script processing engine is then responsible for constructing the presentation. The functionality of what a “submit” means can be implemented in the script. For example, the script may generate a context DI to preserve the state of the form, and may also send this context DI to a target host. e.g.

```
    object formComponents = getObjectOfType(
    “ticketReservationFormComponents”,
                                        “@id=’*_Peak’” );
    object form = constructForm( formComponents );
    object formResult = presentForm( form, formEventHandler( ) );
    object address = getObjectOfType( “providerServerAddress” );
    sendObject( formResult, address );
...
object constructForm( formComponents ) {
    ...
}
void formEventHandler( event ) {
}
```

### EXAMPLE 9

### Scripting Language Example for Presenting a Form

In some instances a resource may describe a form in some other language, such as HTML, and the functionality of the form is contained wholly within the form definition and dependent on the way in which a form of that media type is handled, for example, by an external web browser configured in user preferences.

The generation of a context DI based on current state of the content DI, and transmission to a target host, embodies an implementation of Session Mobility as described in Australian Patent Application No. PR8152.

Display Resources and Operations as Options

This can be achieved in a similar manner to constructing and presenting a form. The script can request a function to create a display area on the device (for example, on a desktop computer, this may be implemented by the script processing engine as an operating system window). The script can then retrieve the required elements from the Digital Item, and can also create its own elements representing operations it defines. These can be composed into the required layout and then presented to the user on the device.

The script can also check the capabilities provided by the device. For example, if supported, the script can request that the device make menu Items available within the user interface. e.g.

...

if( system.hasFeature( “MenuInterface”) ) {

object menuItem = new linkObject( “Transfer context”,

transferContext() );

system.addMenuItem( menuItem );

}

...
void transferContext() {
}

### EXAMPLE 10

### Scripting Language Example for Adding a Component to Device User Interface

Present an Item, Resource or Set Thereof

This functionality allows the presentation of an Item, resource, or a set thereof in a defined manner.

The actual presentation information may be fully contained within the resource, for example, if the resource refers to a Synchronized Multimedia Integration Language (SMIL) presentation, then when that resource is played, the player will need to be able to correctly interpret the SMIL data and so make the required presentation. Information regards SMIL can be found at W3C, Synchronized Multimedia Integration Language (SMIL 2.0), http://www.w3.org/TR/smil20/.

In other cases a method may define its own manner of presentation and the script can be authored in such a way as to construct the presentation and display it to the user.

In other cases the presentation information can be included in some other, possibly standard, format in the Digital Item, and this information can be retrieved by the script and then passed in to the function that requests the presentation to be displayed. e.g.

...

object smilPresentation =
getObjectOfType( “PromotionalSlideShow” );
launchApplication( smilPlayer, smilPresentation );

...

object myWindow = buildPesentation();
present( myWindow );

...

object presentationInfo =
getObjectOfType( “standardPrentationInfo” );
object presentation = getObjectOfType( “albumIterview” );
present( presentation, presentationInfo );

...
object buildPresentation() {
}

### EXAMPLE 11

### Scripting Language Examples of Presenting Items

Launch Application Supplied as Resource

This functionality allows the inclusion of some other application as a resource in the Digital Item. The script can then be authored to launch this application and provide it with certain resources from the Digital Item.

In authoring such a script the author will need to consider such issues as cross-platform support. For example, Java based applications may be chosen for the platform independence of such applications.

The application may be included in the Digital Item (in which case it would be encoded, and need to be decoded), or the Digital Item may contain a reference to a location from which the application may be retrieved. The manner of invoking the application may also be dependent on the application, and possibly the execution environment of the device, and will also need to be considered when authoring such functionality in a script. In addition security issues need to be considered. For example, the script processing engine could warn users before downloading, installing, or running an application and allow them to cancel the operation. e.g.

object album = getObjectOfType( “standardMusicAlbum” );
object track = choseTrack( album );
if( track != null ) {

object audioComponent = getChildObjectOfType(

track, “standardMusicAlbumTrackAudio” );

object audioPlayer = getApplication( “audioPlayer” );
if( audioPlayer != null )

launchApplication( audioPlayer, audioComponent );

else

play( audioComponent );

}

### EXAMPLE 12

### Scripting Language Example for Launching an External Application

This can be extended to allow launching of any other external application that is made available to the script by some other manner.

Add Information to DI in a Defined Way

This functionality allows an author to ensure that the structure of a Digital Item is maintained in a defined way. It can be achieved by allowing the user, with appropriate rights, to only edit the Digital Item via a Digital Item Manipulation method. In this way, the author retains control of where in the Digital Item new information is added. e.g.

addTrack( track ) {

# Make sure new tracks are only
appended as sub-Item of AlbumTracks Item
object albumTracks =
getObjectOfType( “standardMusicAlbumTracks” );
appendChild( albumTracks, track );

}

### EXAMPLE 13

### Scripting Language Example for Adding an Element to a Digital Item at a Defined Place

This also demonstrates that the script author can control how any information may be added to (or removed from) the Digital Item. For example, revision information can be added to the Digital Item in a defined way when a modification to the Digital Item is made, or a new version of the Digital Item is generated for some purpose. This also allows the script to ensure that modifications to the Digital Item are legal, in regards to the correct structure for a Digital Item of the specified type.

Offer HELP Information for a Digital Item From a Resource

This functionality allows help information to be included in the Digital Item. It can be embedded as a resource in the Digital Item, or else the resource can reference an external source. Access to the help information is the same as for any other resource, the script retrieves the object representing that resource. The resource containing the help information can then be displayed to the user as required.

Handling of Descriptors, etc

This functionality allows the script to pass data to other modules for processing. For example, the script can query if the system is able to process a set of Descriptors (possibly via a plug-in module). This may be done, for example, based on the namespace associated with the content of the Descriptors. e.g.

...

object trackInfo =
getObjectOfType( “standardMusicAlbumTrackInfo” );
if( descriptorNamespaceSet.contains( trackInfo.namespace ) ) {

object handler =
system.getDescriptorModule( trackInfo.namespace

);

if( handler != null ) {

callModule( handler, trackInfo );

}

}
...

### EXAMPLE 14

### Scripting Language Example for External Module Handling of Descriptors

Presentation of Choices

This functionality allows control over the presentation of Choices contained in the Digital Item to the user. Information, if available, such as the order in which choices should be presented, precedence of choices, and other such information can be utilised for purposes of this control. The actual presentation may be achieved in a similar manner as for forms, Item/resource presentation, etc,

Local File Storage

This functionality allows the script to store information locally in files, if supported by the execution environment. Typically, security issues will need to be considered. e.g.

void saveContext() {
...

object theDI = getObjectOfType( “standardDigitalItemRoot” );
object contextDI = generateContext ( theDI );
fileObject file = new fileObject( “mycontext.xml” );
writeContextToFile( contextDI, file );

...
}
diObject generateContext( diObject contentDI ) {

...

}
void writeContextToFile( diObject contextDI, fileObject file ) {

try {

file.open( “read” );
file.println( “<?xml version=\“1.0\” encoding=\“UTF-8\”?>” );

...

}
onError {

...

}
}

### EXAMPLE 15

### Scripting Language Example for Storing Information to a Local File

Send DIA Information Back to Server

This functionality allows the script to send Digital Item adaptation information, such as device capabilities, back to the server providing the Digital Item. This could be used, for example, in negotiating the particular resource to be provided. e.g.

...

object displaySize = system.getCapability(
“terminal.hardware.displaySize” );
object cpuSpeed =
system.getCapability( “terminal.hardware.cpuSpeed” );
object diaMsg = constructDIAMessage( displaySize, cpuSpeed );
sendObject( diaMsg, serverAddress );
try {

object response = receiveObject( serverAddress );

}
onError {

object errorInfo = getErrorInformation();
if( errorInfo.error == error.networkTimeout ) {

...

}

}

...

### EXAMPLE 16

### Scripting Language Example for Sending DIA Information to Server and Negotation of Capabilities

Device Configuration

This functionality allows the script to configure certain parts of a device to the Digital Item using Digital Item adaptation information. For example, a Digital Item containing a user's preferences may specify a preferred volume for audio output. The script can obtain this information and set the audio volume of the system accordingly. e.g.

...

object volumePref = system.getObjectOfType(
“userCharacteristics.presentationPreferences.preferredAudioLevel” );
object presentation = new basicPresentationInfoObject();
presentation.volumeLevel = volumePref;
...

### EXAMPLE 17

### Scripting Language Example of Device Configuration

Perform IPMP Operations and Evaluate Rights Information

This functionality allows the script to perform IPMP related operations. In the implementation the actual operations may be executed by a separate IPMP processing engine. The functionality within the scripting language provides the means for interfacing with this IPMP processing engine so that the script may correctly implement IPMP and rights management.

IPMP and rights management may also be handled by the device and/or script processing engine directly, for example, in determining whether to make available or not an element. However, this functionality is provided in the scripting language so that this level of control is also available within a Digital Item manipulation method, if desired. e.g.

...

object theDI = getObjectOfType( “standardDigitalItemRoot” );
if( IPMP_isProtected( theDI ) ) {

...
try {

object accessibleDI = IPMP_process( theDI );

}
onError {

object errorInfo = getErrorInfo();
# Display an alert window with error message.

}
...

}

...

### EXAMPLE 18

### Scripting Language Example of IPMP Operations

Identify Items According to Digital Item Identification (DII)

The DII [3] is a part of the MPEG-21 framework and allows Items to be uniquely identified utilising a specified identification system. Since the DII specifies a standard manner for associating this identification information with Items, the scripting language can provide functions specific to DII. e.g.

...

object id = getObjectIdentification( theMusicAlbum );

...

### EXAMPLE 19

### Scripting Language Example of Possible DII Related Functions

Responding to Events

This area of functionality allows responses to user events such as keystrokes and mouse clicks, and also other events such as device events, or changes to environmental information encapsulated in DIA descriptors. Responding to events can be achieved by, for example, associating an event handler function with the event. In some cases, the event handler is associated with a user interface object that generates the events. e.g.

...

object submitButton = new buttonObject();
setUIObjectEventHandler( submitButton, doSubmit(), myData );
...

void doSubmit( event, myData ) {

...
sendObject( constructMyMsg( myData ), address );
...

}
...

### EXAMPLE 20

### Scripting Language Example of Responding to User Event

Specification of Available Elements

The mapping of the Digital Item elements to object type can also include other information. For example, information can be provided to specify whether an element should be made available (for display and/or selection).

Error Handling

The following examples demonstrate how error handling can be embodied in the scripting language.

...

try {

load( Item );
play( Item );

}
onError {

errorObject error = getErrorInfo();
if( error != null ) {

...

}
...

}

...

### EXAMPLE 21

### Scripting Language Example for Error Handling or:

...

setErrorHandler( handleLoadError() ) {

load( Item );

}

...
void handleLoadError() {

...

}
...

### EXAMPLE 22

### Scripting Language Example for Error Handling

The above examples illustrate explicit error handling within the script. The script processing engine is also required to handle other error situations that may not be handled by the script. For example, the engine can report the error to the device, which in turn can display an error message to the user and/or log the error to a local file.

Timed Events

This functionality allows actions to take place at specified times. For example, a method invoked on receipt of a Digital Item may display a “welcome” image for 3 seconds, then present a “main screen” to the user. e.g.

void displayTravelKiosk() {

object welcomeImage = getObjectOfType( “welcomeImage” );
object welcomeMusic = getObjectOfType) “welcomeMusic” );
object mainScreenPresentation = buildMainScreen();
play( welcomeMusic );
display( welcomeImage, “duration=‘3s’ wait=‘true’” );
present ( mainScreenPresentation );

}
...
object buildMainScreen() {

...
object gotoBoookingFormLink = new
linkObject( bookingFormLinkText,
runBookingForm() );
...

}
...
void runBookingForm() {

...

}
...

Multiple Input/Output Hardware

This functionality provides to the script information concerning the input and output hardware available at the device. For example, if there are three displays, the script can be authored to choose the display with the largest display area. e.g.

...

# get the default display device
object display = system.getObjectOfType( “display” );
...
forEach( system.getObjectsOfType ( “display”, testSize() );
...

void testSize( displayToo ) {

if( displayToo != display ) {

if( (displayToo.width > display.width)
&& (displayToo.height > display.height ) {

display = displayToo;

}

}

}
...

### EXAMPLE 23

### Scripting Language Example Showing Access to Multiple Displays

This list is non-exhaustive and describes only the functionality of a preferred embodiment of the scripting language.

It is important to note that this is not a presentation scripting language—a language such as SMIL may be invoked by the DIScript for the presentation of certain resources. However, the DIScript is focussed purely on the operations that are required to process a Digital Item. DIScript functionality is made unique by its processing of elements of a DI. DIScript would be independent of operating system. DIScript may be held as XML, text or as a binary form of script for efficient transmission.

Scripting Language Examples

The following examples provide partial listings of possible implementations for some standard music album processing methods using the preferred embodiment of the scripting language.

# Method: Standard Music Album:displayAlbum
# Description: standard DIScript to display
the album on receipt by terminal
# Organisation: music org
# Author: Joe Bloggs
# Version: 1.0
# Release date: 2002-07-01
void displayAlbum() {

# Grab the mandatory Album Title identified by standard

# Digital Item title object
object albumTitle = getObjectOfType( “standardDigitalItemTitle”);
# Grab optional album cover image
object albumCover = getObjectofType
( “standardMusicAlbumCover” );
# Display the album title and, if available, the album cover image.
display( albumTitle );
if( albumCover != null ) {

display ( albumCover);

}
# Now list each track.
forEach( getObjectsOfType(“standardMusicAlbumTrack”),

listTrack );

}
boolean listTrack( track ) {

# Grab mandatory track title
object trackTitle =

getChildObjectOfType( track,

“standardMusicAlbumTrackTitle” );

object trackListing = new linkObject(trackTitle,
playTrack( track ) );
display( linkObject );
return true;

}

### EXAMPLE 24

### Scripting Language Example for a Possible Method to Display Digital Item Representing a Music Album

The DIScript function getObjectOfType returns the first object of the specified type as identified in the Digital Item element to script object mapping. The getObjectsOfType function returns the set of all objects of the specified type. The forEach function acts on a set of objects and calls the specified sub-method for each object in the set. The getChildObjectOfType function gets the first child object of the specified parent object where the child object is of the specified type. A linkObject is a specialised object that links a display object to the calling of a function/method.

# Method: Standard Music Album:previewTracks
# Description: standard DIScript to preview tracks
# Organisation: music org
# Author: Joe Bloggs
# Version: 1.0
# Release date: 2002-07-01
declarations {

constant int DEFAULT_PREVIEW_DURATION = 15;
object previewWindow;
object titleTrackText;
object currentTrack;
object nowPlaying;
boolean isStopped;

}
void previewTracks() {

# Create a display window for the preview.
It will contain a static
# text field for the track title, and a push button for user to
# stop the preview operation
previewWindow = new windowObject();
titleTrackText = new textLabelObject( “” );
previewWindow.placeObject( titleTrackText, ...? );
object stopButton = new buttonObject( “Stop”, stopPreview() );
previewWindow.placeObjectBelow( titleTrackText,
stopButton, ...? );
previewWindow.show();

# Now preview each track.

isStopped = false;
forEach( getObjectsOfType(“standardMusicAlbumTrack”),

previewTrack );

}
boolean previewTrack( track ) {

currentTrack = track;
object trackTitle = getChildObjectOfType( currentTrack,

“standardMusicAlbumTrackTitle” );

titleTrackText.setText( trackTitle );
nowPlaying = getChildObjectOfType( currentTrack,

“standardMusicAlbumTrackAudioPreview”

if( nowPlaying == null
&& systemHasFeature(
“urn:mpeg:mpeg21:discript:StandardAudio:
createAudioSubset” ) ) {

object audio = getChilObjectOfType( currentTrack,

“standardMusicAlbumTrackAudio” );

int duration = DEFAULT_PREVIEW_DURATION;
if( hasAttribute( audio, “previewDuration” ) ) {

duration = getAttributeInt ( audio,
“previewDuration” );

}
nowPlaying = createAudioSubset( audio, duration );

}
if( nowPlaying != null ) {

playAndWait( nowPlaying );

}
return !isStopped;

}
void stopPreview() {

isStopped = true;
if(nowPlaying!= null ) {

stop (nowPlaying);
nowPlaying = null;

}
previewWindow.close();

}

### EXAMPLE 25

### Scripting Language Example for a Possible Method to Preview each Track in a Digital Item Representing a Music Album

The following shows how a method availability may be conditional upon a choice within the Digital Item which may be configured by DIA information.

...
<Choice id=“pedagogicalContext”>

<Selection id=“pedagogicalContext_preSchool” />
<Selection id=“pedagogicalContext_primarySchool” />
<Selection id=“pedagogicalContext_secondarySchoolJunior” />
<Selection id=“pedagogicalContext_secondarySchoolSenior” />
<Selection id=“pedagogicalContext_tertiaryEducationUndergraduate” />
<Selection id=“pedagogicalContext_tertiaryEducationPostgraduate” />
...

</Choice>
...
<Descriptor>

<Statement type=“text/discript+xml”>

<discript:method

id=“urn:mpeg:mpeg21:discript:2002:01:StandardLearningObject:displayLearingObjec
t”
ref=“http://mpeg.telecomitalialab.com/discript/2002/01/StandardLearningObject/
displayLearingObject.dsl”

desc=“Run tutorial”
invokeOn=“receipt” />

</Statement>

</Desciptor>
...
<Descriptor>

<Condition require=“pedagogicalContext_tertiaryEducationUndergraduate”

/>

<Statement type=“text/discript+xml”>

<discript:method

id=“urn:mpeg:mpeg21:discript:2002:01:StandardLearningObject:undergraduateTutori
al”
ref=“http://mpeg.telecomitalialab.com/discript/2002/01/StandardLearningObject/u
ndergraduateTutorial.dsl”

desc=“Run tutorial”
invokeOn=“userSelection” />

</Statement>

</Desciptor>
...

### EXAMPLE 26

### Example of Conditional Availability of a Method Incorporated in a Digital Item

It will be appreciated that further embodiments and exemplifications of the invention are possible without departing from the spirit or scope of the invention described.

References

The following references are incorporated herein by cross-reference.
[1] ISO/IEC, MPEG-21 Overview v. 4, ISO/IEC JTC1/SC29/WG11/N4801, May 2002, Fairfax, USA.
[2] ISO/IEC, MPEG-21 Digital Item Declaration FCD, ISO/IEC FCD 21000-2, December 2001, Pattaya, Thailand.
[3] ISO/IEC, Information Technology—Multimedia Framework (MPEG-21)—Part 3. Digital Item Identification, ISO/IEC FCD 21000-3, Mar. 15, 2002.
[4] ISO/IEC, MPEG-21 Digital Item Adaptation WD (v 1.0), ISO/IEC JTC1/SC29/WG11/N4819, May 2002, Fairfax, VA., USA.
[5] ISO/IEC, MPEG-Rights Expression Language WD v 3.0, ISO/IEC JTC1/SC29/WG11/N4816, May 2002, Fairfax, USA.

1. A method of enabling a Digital Item to be consumed or otherwise manipulated according to a set of operations defined by the Digital Item author or other entitled party, the method including the step of incorporating a Digital Item manipulation method or methods defining said set of operations into the Digital Item.

2. A method of enabling a Digital Item to be consumed or otherwise manipulated according to a set of operations defined by the Digital Item author or other entitled party, the method includes the following steps:
incorporating a Digital Item manipulation method or methods defining said set of operations into a Digital Item;
providing said Digital Item, or a Digital Item declaration to a device; enabling said device to:
a. determine an appropriate Digital Item manipulation method or methods for the application;
b. retrieve said appropriate Digital Item manipulation method or methods;
c. interpret said set of operations from said appropriate digital item manipulation method or methods; and
d. perform interpreted set of operations from said digital item manipulation method or methods on said -digital item:

3. A method of enabling a Digital Item to be consumed or otherwise manipulated according to a set of operations defined by the Digital Item author or other entitled party, the method includes the following steps:
incorporating a Digital Item manipulation method or methods defining said set of operations into a Digital Item;
providing said Digital Item, or a Digital Item declaration to a device; enabling said device to:
determine an appropriate Digital Item manipulation method or methods for the application;
retrieve said appropriate Digital Item manipulation method or methods;
receive and be configured on the basis of other predetermined information;
interpret said set of operations from said appropriate Digital Item manipulation method or methods; and
perform said interpreted set of operations from said Digital Item manipulation method or methods on said Digital Item.

4. A method of enabling a Digital Item to be consumed or otherwise manipulated according to a set of operations defined by the Digital Item author or other entitled party, the method includes the following steps:
incorporating a Digital Item manipulation method or methods into a Digital Item defining said set of operations;
providing said Digital Item, or a Digital Item declaration to a device;
enabling said device to:
determine an appropriate Digital Item manipulation method or methods for the application;
retrieve said appropriate Digital Item manipulation method or methods;
configure said appropriate Digital Item manipulation method or methods for said Digital Item;
interpret said set of operations from said appropriate Digital Item manipulation method or methods; and
perform said interpreted set of operations from said Digital Item manipulation method or methods on said Digital Item.

5. A method of enabling a Digital Item to be consumed or otherwise manipulated according to a set of operations defined by the Digital Item author or other entitled party, the method includes the following steps:
incorporating a Digital Item manipulation method or methods defining said set of operations into a Digital Item;
providing said Digital Item, or a Digital Item declaration to a device; enabling said device to:
determine an appropriate Digital Item manipulation method or methods for the application;
retrieve said appropriate Digital Item manipulation method or methods;
configure said appropriate Digital Item manipulation method or methods for said Digital Item;
receive and be configured on the basis of other predetermined information;
interpret said appropriate Digital Item manipulation method or methods; and
perform said interpreted operations from said Digital Item manipulation method or methods on said Digital Item.

6. A method according to claim 5 wherein the Digital Item manipulation method is provided within the Digital Item or the Digital Item declaration.

7. A method according to claim 5 wherein the other predetermined information includes information regarding user preferences, device capabilities and/or consumption environment.

8. A method according to claim 1 wherein the Digital Item manipulation method includes an Intellectual Property Management and Protection (IPMP) mechanism.

9. A method according to claim 8 including the step of protecting said device using said IPMP mechanism.

10. Apparatus for enabling a Digital Item to be consumed or otherwise manipulated according to a set of operations defined by the Digital Item author or other entitled party, the apparatus including:
means for incorporating a Digital Item manipulation method or methods defining said set of operations into a Digital Item;
means for providing said Digital Item, or a Digital Item declaration to a device; said device including:
means for determining an appropriate Digital Item manipulation method or methods for the application;
means for retrieving said appropriate Digital Item manipulation method or methods;
means for interpreting said set of operations from said appropriate Digital Item manipulation method or methods; and
means for performing said interpreted set of operations from said Digital Item manipulation method or methods on said Digital Item.

11. Apparatus for enabling a Digital Item to be consumed or otherwise manipulated according to a set of operations defined by the Digital Item author or other entitled party, the apparatus including:
means for incorporating a Digital Item manipulation method or methods defining said set of operations into a Digital Item;
means for providing said Digital Item, or a Digital Item declaration to a device; said device including:
means for determining an appropriate Digital Item manipulation method or methods for the application;
means for retrieving said appropriate Digital Item manipulation method or methods;
means for receiving and being configured on the basis of other predetermined information;
means for interpreting said set of operations from said appropriate Digital Item manipulation method or methods; and
means for performing said interpreted set of operations from said Digital Item manipulation method or methods on said Digital Item.

12. Apparatus for enabling a Digital Item to be consumed or otherwise manipulated according to a set of operations defined by the Digital Item author or other entitled party, the apparatus including:
means for incorporating a Digital Item manipulation method or methods defining said set of operations into a Digital Item;
means for providing said Digital Item, or a Digital Item declaration to a device; said device including:
means for determining an appropriate Digital Item manipulation method or methods for the application;
means for retrieving said appropriate Digital Item manipulation method or methods;
means for configuring said appropriate Digital Item manipulation method or methods for said Digital Item;
means for interpreting said set of operations from said appropriate Digital Item manipulation method or methods; and
means for performing said interpreted set of operations from said Digital Item manipulation method or methods on said Digital Item.

13. Apparatus for enabling a Digital Item to be consumed or otherwise manipulated according to a set of operations defined by the Digital Item author or other entitled party, the apparatus including:
means for incorporating a Digital Item manipulation method or methods defining said set of operations into a Digital Item;
means for providing said Digital Item, or a Digital Item declaration to a device; said device including:
means for determining an appropriate Digital Item manipulation method or methods for the application;
means for retrieving said appropriate Digital Item manipulation method or methods;
means for configuring said appropriate Digital Item manipulation method or methods for said Digital Item;
means for receiving and being configured on the basis of other predetermined information;
means for interpreting said set of operations from said appropriate Digital Item manipulation method or methods; and
means for performing said interpreted operations from said Digital Item manipulation method or methods on said Digital Item.

14. A method according to claim 1 wherein said set of operations is described in a script.

15. A method according to claim 14 wherein said script is included in the Digital Item as a resource within the Digital Item accessed by a reference URI from the Digital Item declaration

16. A method according to claim 14 wherein said script is provided within the Digital Item declaration itself as a descriptor

17. A method according to claim 14 wherein said script is referenced by an identifier such that a device, or a family of devices might have the operations of said script in-built at manufacture or by later modification

18. Apparatus according to claim 10 wherein the Digital Item manipulation method includes an Intellectual Property Management and Protection (IPMP) mechanism.

19. Apparatus according to claim 18 including means for protecting said device using said IPMP mechanism.

20. Apparatus according to claim 10 wherein said set of operations are described in a script.

21. Apparatus according to claim 20 wherein said script is included in the Digital Item as a resource within the Digital Item accessed by a reference URI from the Digital Item declaration

22. Apparatus according to claim 20 wherein said script is provided within the Digital Item declaration itself as a descriptor

23. Apparatus according to claim 20 wherein said script is referenced by an identifier such that a device, or a family of devices might have the operations of said script in-built at manufacture or by later modification

24. A method according to claim 1 including a step of determining whether the device can perform the Digital Item manipulation method.

25. A method according to claim 24 further including the step of identifying elements of the Digital Item which can be processed by the Digital. Item manipulation method.

26. Apparatus according to claim 10 including means for determining whether the device can perform the Digital Item manipulation method.

27. Apparatus according to claim 26 further including means for identifying elements of the Digital Item which can be processed by the Digital Item manipulation method.
